(19) United States
(12) Patent Application Publication
(10) Pub. No.: US 2009/0015932 A1
(43) Pub. Date: Jan. 15, 2009

(54) METHOD FOR MANUFACTURING FILM COATED LENS

(75) Inventor: SHIH-CHE CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/106,519

(22) Filed: Apr. 21, 2008

(30) Foreign Application Priority Data
Jul. 13, 2007 (CN) 200710201071.8

(51) Int. Cl. G02B 3/00

(52) U.S. Cl. 359/642

(57) ABSTRACT

A method for manufacturing film coated optical lens includes steps: providing a lens array panel including an array of lens units; forming an optical film on opposite surfaces of the lens array panel; cutting the lens array panel into pieces, thereby obtaining a plurality of separated lenses with the optical film formed on opposite surfaces thereof.

### BACKGROUND

1. Field of the Invention

The present invention relates to a method for manufacturing optical lenses and, particularly, to a method for manufacturing a lens with a film coated thereon.

2. Description of Related Art

Optical lenses, such as aspheric lenses and ball-shaped lenses are widely used as elements of lens modules. Generally, optical lenses are manufactured by injection moldings. Sometimes, the lens need an optical film coated thereon so as to increase optical performances thereof. The optical film can be an anti-reflection film, an infrared ray-cut film, etc.

Referring to FIGS. 7 to 9, a conventional method for coating a surface of a lens is provided as follows:

Firstly, a tray group including a first tray 10 and a second tray 20 is provided. The first tray 10 defines a plurality of through holes 12 in rows and columns therein. Four location pins 14 protrude out from one surface of the first tray 10. The first tray 10 and second tray 20 are substantially cubic shaped. Each of the location pins 14 is disposed at one corner of the first tray 10. The second tray 20 defines a plurality of through holes 22 and four location holes 24 therein. The through holes 22 are respectively corresponding to the through holes 12. The four location holes 24 are respectively corresponding to the four location pins 14. Each of the through holes 12 and 22 is in a shape of circular truncated cone. Each of the location pins 14 is configured for inserting through the corresponding location hole 24, so as to fix the first tray 10 and the second tray 20 together. The plurality of through holes 12 cooperate with the plurality of holes 22 to define a plurality of spaces 26. Opening 122 of each of the through holes 12 adjacent to the second tray 20 is wider than the corresponding opening 124 of the through holes 12 away from the second tray 20. Similarly, opening 222 of each of the through holes 22 adjacent to the first tray 10 is wider than the corresponding opening 224 of the through holes 22 away from the first tray 10. A plurality of lenses 30 are received in the spaces 26.

Secondly, the surfaces of the lenses 30 are coated with functional materials by sputtering or other coating methods, and the functional films are formed on the surfaces of the lenses 30. As shown in FIG. 9, because each of the openings is narrower than each of the corresponding openings, peripheral of the surface of the lens 30 may fail to be coated with the functional material. Thus, the optical performance of the lenses 30 may be weakened.

What is needed, therefore, is a method for manufacturing a lens with an optical film coated thereon.

### SUMMARY

In a present embodiment of the present invention, A method for manufacturing film coated optical lens includes steps: providing a lens array panel including an array of lens units; forming an optical film on opposite surfaces of the lens array panel; cutting the lens array panel into pieces, thereby obtaining a plurality of separated lenses with the optical film formed on opposite surfaces thereof.

Advantages and novel features will become more apparent from the following detailed description of the present method for manufacturing a lens with an optical film coated, when taken in conjunction with the accompanying drawings.

### BRIEF DESCRIPTION OF THE DRAWINGS

Many aspects of the present method for manufacturing a lens with an optical film coated can be better understood with reference to the following drawings. The components in the drawings are not necessarily drawn to scale, the emphasis instead being placed upon clearly illustrating the principles of the present method for manufacturing a lens with an optical film coated. Moreover, in the drawings, like reference numerals designate corresponding parts throughout the several views.

FIG. 1 is a flow chart of a method for manufacturing lenses with an optical film formed thereon in accordance with a present embodiment.

FIG. 2 is a schematic, cross-sectional view of a sheet and a hot press mold configured for molding the sheet used in the method in FIG. 1.

FIG. 3 is a schematic, cross-sectional view of the hot press mold in FIG. 2, which is pressing the sheet.

FIG. 4 is a schematic, perspective view of a lens array panel which is formed from molding the sheet by the hot press mold in FIG. 3.

FIG. 5 is a schematic, cut-away view of the lens array panel in the FIG. 4 with an optical film formed thereon.

FIG. 6 is a schematic, perspective view of a plurality of lenses which are achieved after cutting the lens array panel with an optical film formed thereon in FIG. 5.

FIG. 7 is an exploded perspective view of a conventional tray group including a first tray and a second tray and a plurality of lenses in accordance with a related art.

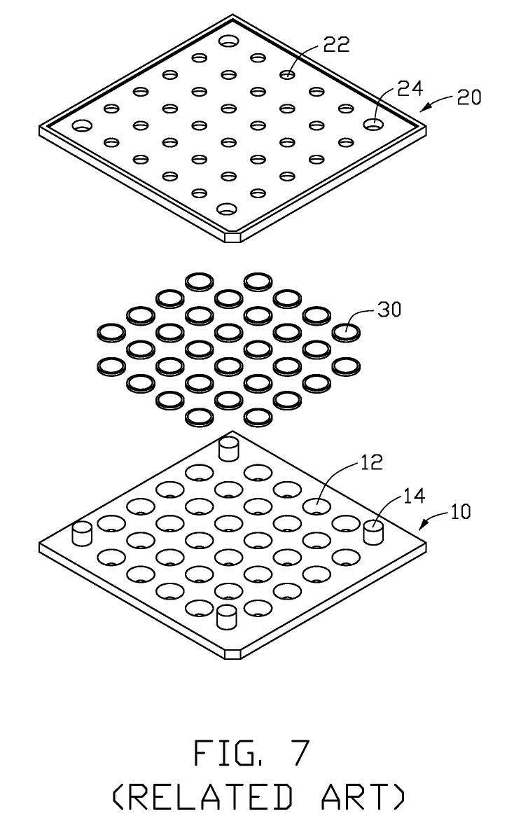

FIG. 8 is a schematic, front view of the tray group in FIG. 6 assembled.

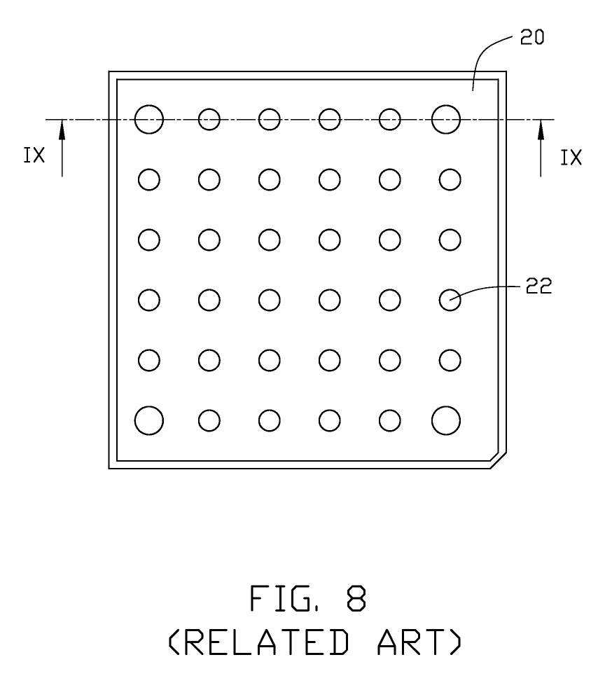

FIG. 9 is a schematic, cross-sectional view of the FIG. 8 along the line IX-IX.

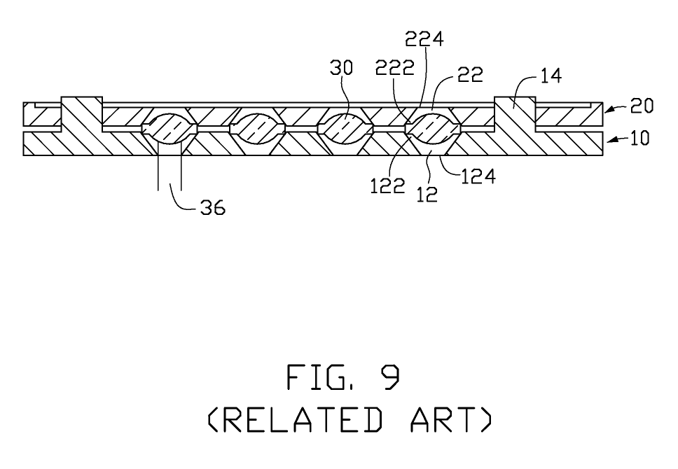

### DETAILED DESCRIPTION OF PRESENT EMBODIMENT

Reference will now be made to the drawings to describe present embodiments of the method for manufacturing lenses with an optical film formed thereon.

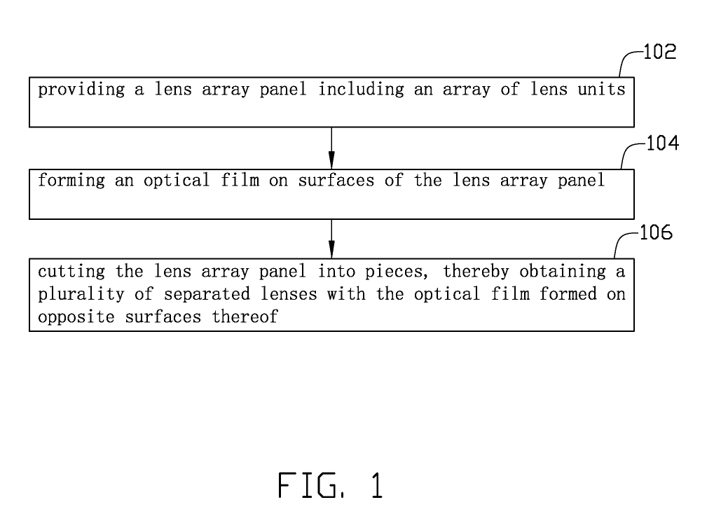

Referring to FIG. 1, a method for manufacturing lenses with an optical film coated is provided in accordance with a present embodiment. The method includes steps: providing a lens array panel including an array of lens units (step 102); forming an optical film on surfaces of the lens array panel (step 104); cutting the lens array panel into pieces, thereby obtaining a plurality of separated lenses with the optical film formed on opposite surfaces thereof (step 106).

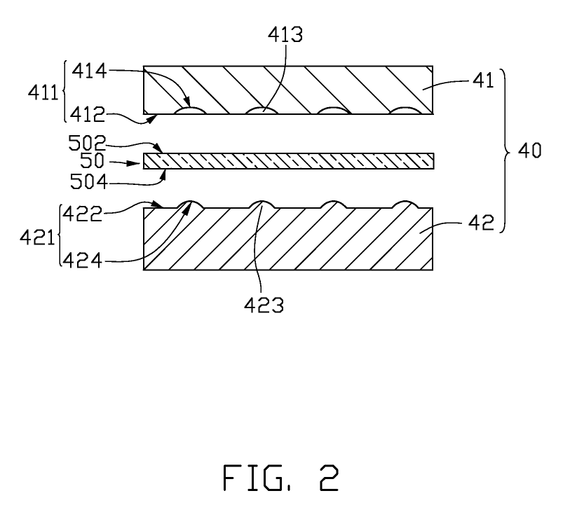

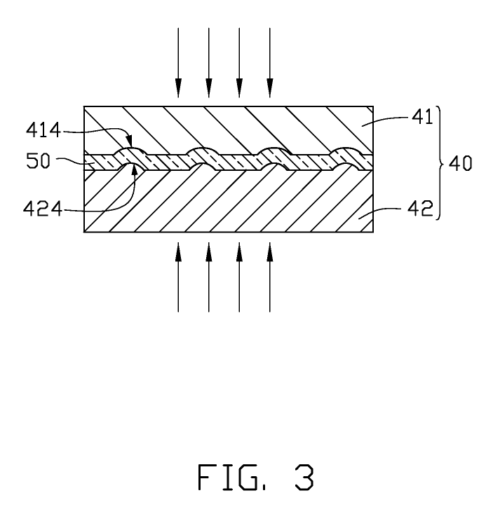

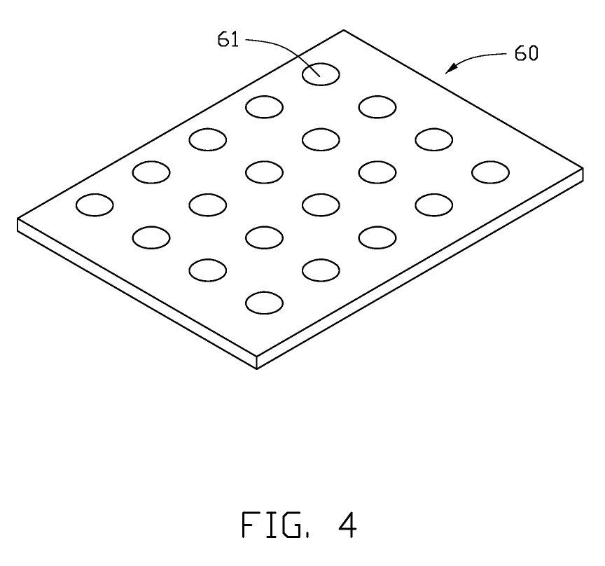

Referring to FIGS. 2 to 6, the method for manufacturing lenses with an optical film coated is described in detail as follow:

Referring to FIGS. 2 to 4, in step 102, a lens array panel 60 is formed in the following steps. Firstly, referring to FIG. 2, a flat sheet 50 having a predetermined thickness is provided. The thickness of the sheet 50 can vary according to needs. The sheet 50 has two surfaces 502 and 504 facing away from each other. The sheet 50 is made of an optical plastic material, which can be selected from a group consisting of polymethyl methacrylate (PMMA), polystyrene, a copolymer of cinnamene and acrylate, polycarbonate, etc.

Secondly, a hot press mold 40 is provided. The hot press mold 40 includes a first mold half 41 and a second mold half 42. The first mold half 41 and the second mold half 42 have a first molding surface 411 and a second molding surface 421, respectively. The first molding surface 411 is set facing to the surface 502 of the sheet 50, and the second molding surface 421 is set facing to the surface 504. The first molding surface 411 includes a plane surface 412. A plurality of concave portions 413 are defined on the plane surface 412. Each of the concave portions 413 has a concave surface 414. The second molding surface 421 includes a plane surface 422 and a plurality of convex portions 423 protruding out from the plane surface 422. Each of the convex portions 423 has a curved surface 424. Each of the concave surfaces 414 and the curved surfaces 424 can be a spherical surface or an aspheric surface and has a central axis. The number of the concave surfaces 414 is same as that of the curved surfaces 424. Each concave surface 414 corresponds to one curved surface 424. Each concave surface 414 and the corresponding curved surface 424 are coaxial. It is to be understood that one of the first molding surface 411 and the second molding surface 421 can be a flat surface.

Thirdly, referring to FIGS. 2 to 4, the sheet 50 is disposed between the molding surface 411 and 412, and thermally softened by heating. The first mold half 41 and the second half 42 are moved toward the surfaces 502 and 504, and pressed firmly against the sheet 50 till the gap between the molding surfaces 411 and 412 is filled with the sheet 50. The sheet 50 between the molding surfaces 411 and 412 is then cooled. Further, a lens array panel 60 is formed after both the first mold half 41 and second half 42 separate from the sheet 50. Preferably, a temperature of the sheet 50 is heated above the glass transmission temperature of the sheet 50.

The lens array panel 60 includes a plurality lens units 61 integrally connected with each other, and each of which has two curved surfaces (not labeled) formed by respectively pressing the molding concaves 413 and the convex portions 423 against the surfaces 502 and 504. Corresponding to coaxiality between each concave 413 and the corresponding curved surface 424, two corresponding surfaces of each lens 61 are coaxial. It is to be understood that the lens array panel 60 may also be manufactured by other method, e.g. injection molding, casting.

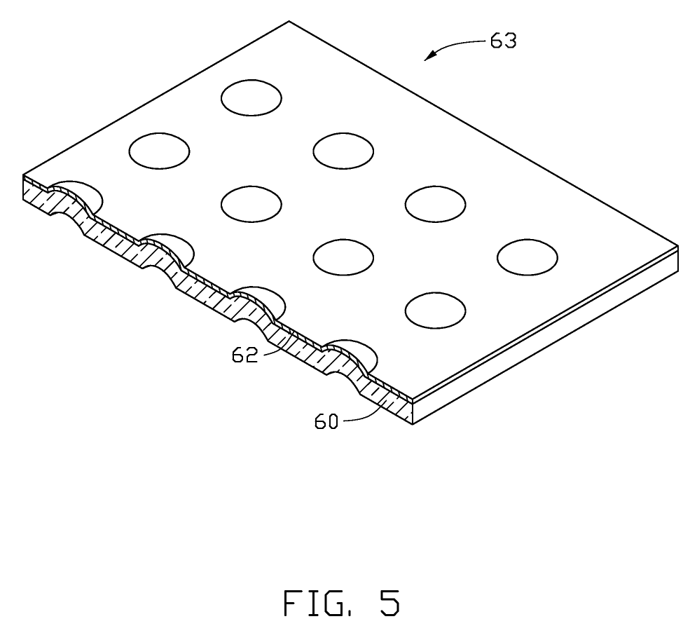

In step 104, the lens array panel 60 is disposed into a vacuum evaporation device (not shown) to coat one surface of the lens array panel 60 with an optical film 62. Referring to FIG. 5, after the lens array panel 60 being coated with the optical film 62, an optical element 63 including the lens array panel 60 and the optical film 62 is formed on the surface of the lens array panel 60. The optical film 62 can be selected from a group consisting of anti-reflective film, Infrared-cut film, etc. The optical film 62 can be a single-layer film or a multi-layer film. It is to be understood that the other surface of the lens array panel 60 can also be coated with an optical film. Furthermore, the surface of the lens array panel 60 can also be coated using other methods, such as sputtering, etc.

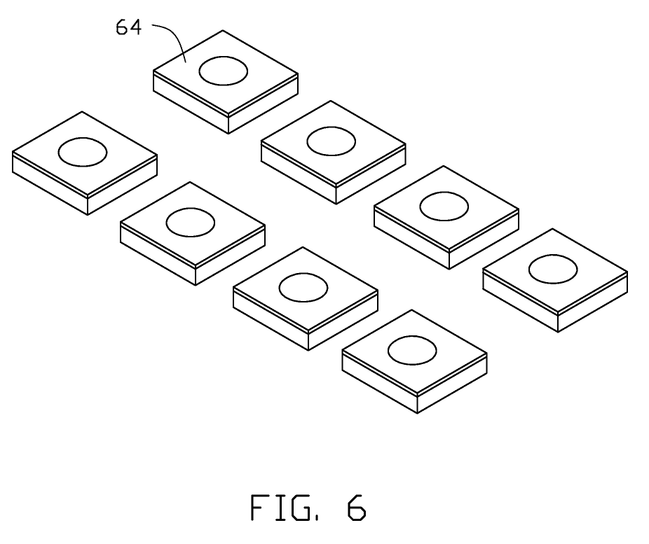

Referring to FIG. 6, in step 106, the optical element 63 is cut by a wafer dicing saw (not shown). The lens units 61 integrally connected with each other are divided into single lenses 64. Each of the lenses 64 has two surfaces, which are coaxial and have same shapes of concave surface 414 and the curved surface 424 respectively. After this step, the lens 64 with the optical film 62 coated is formed. In this step, the wafer dicing saw can be selected from a group consisting of quartz wafer dicing saw and silicon wafer dicing saw. Also, the optical element 63 can be cut using other device, such as laser cutting machine.

It is to be understood that the material of the sheet 50 also can be an optical glass. At that moment, a method of manufacturing the lens array panel 60 can be a stamping method in Step 204.

One of advantages of the method for manufacturing lens with optical film coated is that the optical film covers the entire surface of the lens because of no shelter over the surface of the lens when coating, thus the lens with optical film coated has high optical performance.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing optical lenses, comprising:
providing a lens array panel including an array of lens units;
forming an optical film on opposite surfaces of the lens array panel;
cutting the lens array panel into pieces, thereby obtaining a plurality of separated lenses with the optical film formed on opposite surfaces thereof.

2. The method as claimed in claim 1, wherein the lens array panel is made of optical plastics.

3. The method as claimed in claim 2, wherein the lens array panel is formed using a process selected from the group consisting of a hot press molding process, an injection molding process and a casting process.

4. The method as claimed in claim 3, wherein the hot pressing molding process comprise:
placing a plastic sheet between a first mold half and a second mold half, the first mold half having a first molding surface configured for forming one surface of the lens array panel, the second mold half having a second molding surface configured for forming the other surface of the lens array panel, the first molding surface comprising a flat portion with a plurality of concave portions or convex portions on the flat portion, the concave portions or convex portions configured for forming the respective lens units;
pressing the first mold half and the second mold half at a high temperature sufficient to shape the sheet into the lens array panel; and
cooling the treated sheet to obtain the lens array panel.

5. The method as claimed in claim 4, wherein the second molding surfaces comprising a same number of concave portions or convex portions as that of the concave portions or convex portions of the first molding surface, the concave portions or convex portions of the first molding surface and that of the second molding surface being coaxially aligned with each other.

6. The method as claimed in claim 1, wherein the lens array panel is made of optical glass.

7. The method as claimed in claim 1, wherein the lens array panel is formed using a stamping method.

8. The method as claimed in claim 1, wherein the optical film is formed on the lens array panel using a process selected from the group consisting of evaporation coating and sputtering.

9. The method as claimed in claim 1, wherein the lens array panel is cut using a wafer dicing saw.

10. The method as claimed in claim 1, wherein the optical film is an anti-reflective film.
